(19) United States
(12) Patent Application Publication
(10) Pub. No.: US 2006/0107608 A1
(43) Pub. Date: May 25, 2006

(54) Adaptable door frame apparatus

(76) Inventor: Michael Mirau, Duluth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/994,994

(22) Filed: Nov. 22, 2004

(51) Int. Cl. E06B 1/04

(52) U.S. Cl. 52/211

(57) ABSTRACT

A frame apparatus for a fenestration unit comprising an elongated frame member including a first side and a second side, wherein the largest distance between the first side and the second side defines a width of about 1.25 inches, the elongated frame member also includes a first end and a second end, wherein the largest distance between the first end and the second end defines a length of at least 5.625 inches, wherein the first side includes an exterior notch at least 0.25 inches from the first end, wherein the exterior notch is at least 0.1 inches wide and at least 0.2 inches deep and the second side includes a backcut located at least 2.0 inches from the second end, wherein the backcut measures at least 0.25 inches deep and at least 0.1 inches wide and wherein the elongated frame member includes a ridge.

### FIELD OF THE INVENTION

The present invention relates generally to alignment devices for fenestration units such as, for example, door frames and window units. More particularly, the present invention relates to a door frame with improved installation capabilities.

### BACKGROUND OF THE INVENTION

Door frame assemblies have been utilized in the building industry for many years. Door frames traditionally include a pair of vertically disposed side jambs and a head jamb extending across the upper ends of the side jambs. One of the side jambs is usually termed a hinge jamb while the other side jamb is usually termed a latch jamb. The door frame is normally positioned in a door opening formed in a wall surface. Vertical and horizontal trim members are then positioned at the opposite sides of the door frame to cover the gap between the door frame and the door opening. Traditionally, these door frame members are made of wood, aluminum, steel, plastic and/or fiberglass. The members are normally fabricated from wooden boards, bent steel plates, extruded aluminum, extruded plastic and/or fiberglass.

Traditionally, when installing a door frame in a wall opening, it is often necessary to use a variety of shims or other materials so the door and frame will properly fit in the opening space. This is especially necessary when the opening size is non-standard or irregular. The need for shims and other materials presents a problem because it takes extra time to install a door frame. The use of shims may also damage the appearance or strength of the door frame. Moreover, the need for additional components requires a larger area for vendors to store many different components and materials, and additional personnel to keep track of these components.

Several inventions have been developed to make it easier to install door frames in openings with varying or irregular dimensions. For example, U.S. Pat. No. 4,922,659, issued May 8, 1990 to Muccioli, shows an adjustable door and frame assembly in which the height and width of the frame is adjusted by removing pre-cut portions of the header and jamb members. Similarly, U.S. Pat. No. 5,291,688, issued Mar. 8, 1994 to Pederson discloses a frame that is adjusted by moving an edge portion of the door relative to a central portion. These doors require interfitted moving parts. U.S. Pat. No. 4,825,610, issued May 2, 1989 to Gasteiger and U.S. Pat. No. 5,038,538, issued Aug. 13, 1991 to Rozon show door frames with telescoping frame extension members, which allow the frames to be installed in wall openings of various sizes. U.S. Pat. No. 5,845,439, issued Dec. 8, 1998 to Hendley, disclosed a way of removing some different sizes of the door's core pieces to adjust the door and frame dimension. However, none of the above inventions and patents, taken either singularly or in combination, is seen to describe the instant invention as claimed.

Consumer demand for economical, low maintenance, yet reliable and aesthetically pleasing, door frame assemblies continues to increase year after year. One way to cut costs associated with building and assembling door frame assemblies is to reduce material costs. Another way to cut costs associated with building and assembling door frame assemblies is to reduce labor time. Therefore, there exists a need for a door frame assembly which is economical to manufacture and assemble, which is structurally sound and durable, and which provides a desirable appearance.

### SUMMARY OF THE INVENTION

The invention includes a frame apparatus for a fenestration unit. The apparatus comprises at least one elongated frame member including a first side, a second side, a first end, and a second end. The first side includes an exterior notch proximate the first end. The second side includes at least one backcut proximate the second end and a ridge proximate the first end.

In another embodiment, the invention includes a frame apparatus for a fenestration unit. The frame apparatus comprises an elongated frame member including a first side and a second side. The largest distance between the first side and the second side defines a width of about 1.25 inches. The elongated frame member also includes a first end and a second end. The largest distance between the first end and the second end defines a length of about 5.625 inches. The first side includes an exterior notch at least 0.25 inches from the first end. The exterior notch is at least 0.1 inches wide and at least 0.2 inches deep. The second side includes a backcut located at least 2.0 inches from the second end. The backcut measures at least 0.25 inches deep and at least 0.1 inches wide. The elongated frame member also includes a ridge extending at least 1 inch from the first end and at least 0.25 inches from the second side.

In yet another embodiment, the invention includes a frame apparatus for a door frame. The apparatus comprises an elongated frame member including a first side and a second side. The largest distance between the first side and the second side defines a width of at least 1 inch. The elongated frame member also includes a first end and a second end. The largest distance between the first end and the second end defines a length of about 7.625 inches. The first side includes an exterior notch at least 0.25 inches from the first end. The exterior notch is at least 0.1 inches wide and at least 0.2 inches deep. The second side includes a backcut located at least 2.0 inches from the second end. The backcut measures at least 0.25 inches deep and at least 0.1 inches wide. The elongated frame member also includes a ridge extending at least 1 inch from the first end and at least 0.25 inches from the second side.

### BRIEF DESCRIPTION OF THE DRAWINGS

FIG. 1 is a cross-sectional view of a sidelight frame assembly of the present invention utilizing 6 9/16 inch frame members.

FIG. 2 is a cross-sectional view of a frame assembly of the present invention.

FIG. 3 an isometric view of a door frame utilizing frame members of the present invention.

FIG. 4 is a cross-sectional view of a 6 9/16 inch frame member of the present invention.

FIG. 5 is a cross-sectional view of a 4 9/16 inch frame member of the present invention.

FIG. 6 is a cross-sectional view of a sidelight frame assembly of the present invention utilizing 4 9/16 inch frame members.

FIG. 7 is a cross-sectional view of a transom assembly of the present invention utilizing 6 9/16 inch frame members.

FIG. 8 is a cross-sectional view of a sidelight frame assembly of the present invention utilizing 4 9/16 inch frame members.

FIG. 9 is a cross sectional view of a frame assembly using 0.5 inch interior drywall.

FIG. 10 is a cross sectional view of a frame assembly using 0.625 inch interior drywall.

FIG. 11 is a cross sectional view of a nail fin incorporated in the present invention.

### DETAILED DESCRIPTION OF THE PREFERRED EMBODIMENTS

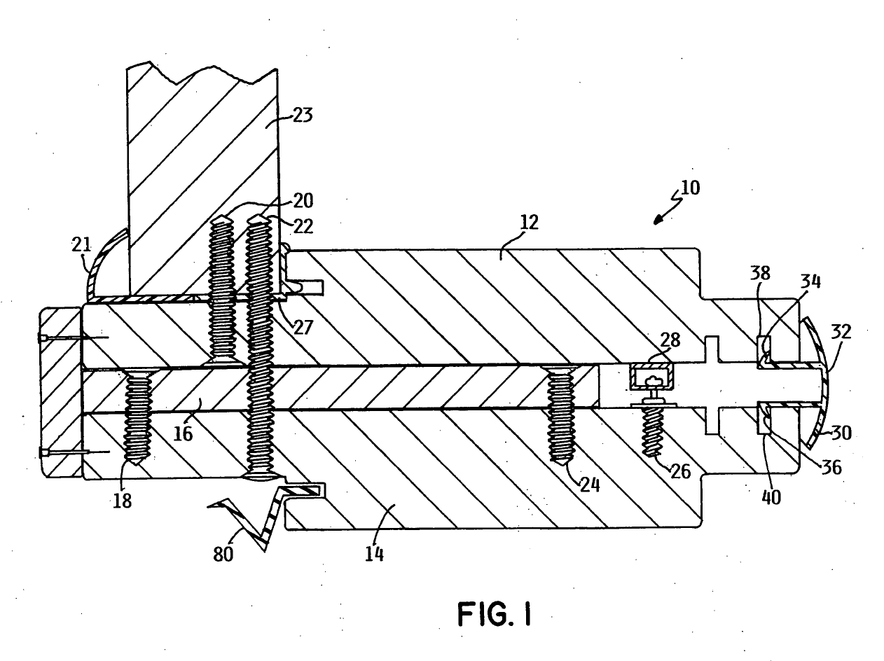

With reference to FIG. 1, a door frame apparatus 10 of the present invention is shown. Apparatus 10 is shown as a sidelight assembly and includes frame members 12 and 14. Frame members 12 and 14 are fastened together through plywood 16 using screws 18, 20, 22, and 24. Clip connector screw 26 is disposed in frame member 14. Mull connection clip 28 is attached to frame member 12, and joins with clip connector screw 26. Spaced mull cover 30 is disposed over a first end of frame members 12 and 14. This gives the apparatus a clean appearance because the exterior profile 32 of cover 30 is visible. Cover 30 also includes a first prong 34 and a second prong 36. This enables the cover 30 to remain in the aperture between frame member 12 and frame member 14. First prong 34 is disposed in exterior notch 38 of frame member 12. Second prong 36 is disposed in exterior notch 40 of frame member 14.

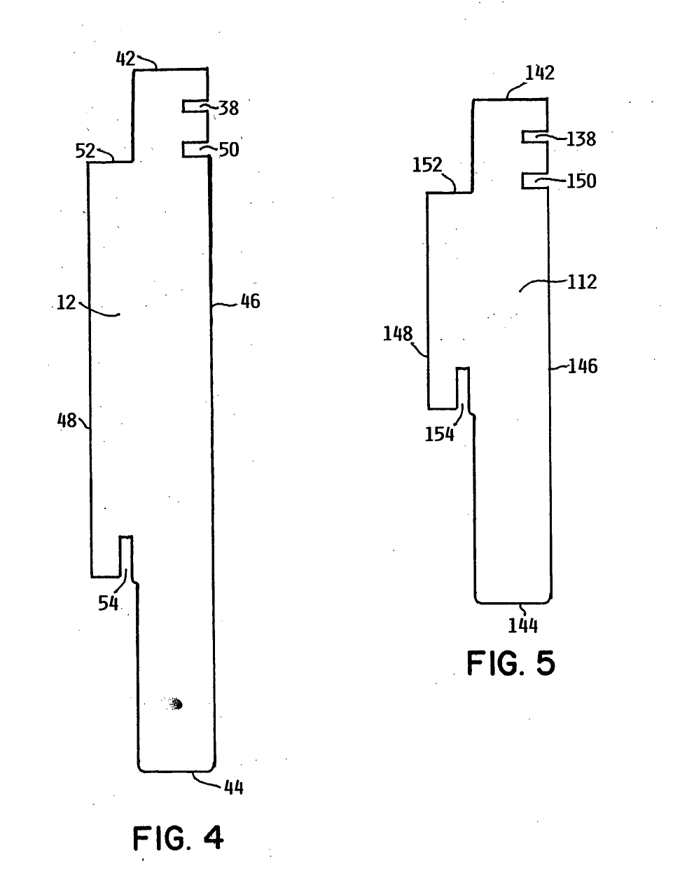

With reference to FIG. 4, the details of frame member 12 will now be discussed. Frame member 12 is symmetrical to frame member 14. The components can be used interchangeably for the purposes of this invention. Frame member 12 includes a first end 42 and a second end 44. Frame member 12 also includes a first side 46 and a second side 48. As disclosed above, exterior notch 38 is disposed on first side 46 proximate first end 42. In a preferred embodiment, interior notch 50 is also located on first side 46 adjacent to exterior notch 38. Ridge 52 is located at first end 42 proximate second side 48. In a preferred embodiment, ridge 52 defines a cutout measuring between 0.5 inches and 1.5 inches long, more preferably about 1.0625 inches long along the second side 48. Ridge 52 preferably measures between 0.25 inches and 0.75 inches wide, more preferably about 0.5 inches wide along the first end 42. Backcut 54 is located on second side 48, proximate second end 44. Backcut 54 defines a lateral groove with a depth of between 0.25 and 0.75 inches, preferably 0.5 inches. Backcut 54 has a width of between 0.0625 and 0.1875 inches, preferably 0.125 inches.

Additional preferred dimensions of frame member 12 will now be discussed. Frame member 12 is about 7.625 inches long from first end 42 to second end 44. This dimension is particularly well suited for structures utilizing 2×6 frame construction. The distance from second end 44 to the center line of interior notch 50 measures between 6 and 7 inches, preferably about 6.7175 inches. The distance from second end 44 to the center line of exterior notch 38 measures between 7 and 8 inches, preferably about 7.1875 inches.

Frame member 12 defines a maximum thickness between first side 46 and second side 48 of between 0.75 inches and 1.5 inches, preferably 1.25 inches. The distance between second end 44 and the beginning of backcut 54 measures between 1.75 inches and 2.75 inches, preferably 2.125 inches. Moreover, the distance between second end 44 and the beginning of ridge 52 measures between 6.0 inches and 7.0 inches, preferably 6.5625 inches. Exterior notch 38 and interior notch 50 can have the same dimensions, although this feature is not necessary for the invention. In a preferred embodiment, exterior notch 38 and interior notch 50 are between 0.125 inches deep and 0.375 inches deep, preferably 0.25 inches deep. Exterior notch 38 and interior notch 50 are between 0.0625 inches wide and 0.1875 inches wide, preferably 0.125 inches wide. The distance between exterior notch 38 and interior notch 50 is between 0.25 inches and 0.75 inches, preferably 0.47 inches.

Jamb jack 99 is located on frame member 12. Jamb jack 99 is a threaded, screw type member that can be used to adjust the distance between stud 70 and frame member 12 without the need for shims. For example, if jamb jack 99 is screwed all the way into frame member 12, the distance between frame member 12 and stud 70 will be larger. If jamb jack 99 is not screwed into frame member 12, the surface of frame member 12 will be tight against stud 70. This aspect of the invention allows for more accurate alignment of frame within a door frame opening. Frame member 12 may include a plurality of jamb jacks for this purpose.

With reference to FIG. 5, the details of frame member 112 will now be discussed. Frame member 112 is similar in many respects to frame member 12. However, frame member 112 is particularly suited to structures utilizing a 2×4 frame construction. Frame member 112 includes a first end 142 and a second end 144. Frame member 112 also includes a first side 146 and a second side 148. Exterior notch 138 is disposed on first side 146 proximate first end 142. In a preferred embodiment, interior notch 150 is also located on first side 146 adjacent to exterior notch 138. Ridge 152 is located at first end 142 proximate second side 148. In a preferred embodiment, ridge 152 defines a cutout measuring between 0.5 inches and 1.5 inches long, more preferably about 1.0625 inches long along the second side 148. Ridge 152 preferably measures between 0.25 inches and 0.75 inches wide, more preferably about 0.5 inches wide along the first end 42. Backcut 154 is located on second side 148, proximate second end 144. Backcut 154 defines a lateral groove with a depth of between 0.25 and 0.75 inches, preferably 0.5 inches. Backcut 154 has a width of between 0.0625 and 0.1875 inches, preferably 0.125 inches.

Additional preferred dimensions of frame member 112 will now be discussed. Frame member 112 is about 5.625 inches long from first end 142 to second end 144. This dimension is particularly well suited for structures utilizing 2×4 construction. The distance from second end 144 to the center line of interior notch 150 measures between 4 and 5 inches, preferably about 4.7175 inches. The distance from second end 144 to the center line of exterior notch 138 measures between 5 and 6 inches, preferably about 5.1875.

Frame member 112 defines a maximum thickness between first side 146 and second side 148 of between 0.75 inches and 1.5 inches, preferably 1.25 inches. The distance between second end 144 and the beginning of backcut 154 measures between 1.75 inches and 2.75 inches, preferably 2.125 inches. Moreover, the distance between second end 144 and the beginning of ridge 152 measures between 4.0 inches and 5 inches, preferably 4.5625 inches. Exterior notch 138 and interior notch 150 can have the same dimensions, although this feature is not necessary for the invention. In a preferred embodiment, exterior notch 138 and interior notch 150 are between 0.125 inches deep and 0.375 inches deep, preferably 0.25 inches deep. Exterior notch 138 and interior notch 150 are between 0.0625 inches wide and 0.1875 inches wide, preferably 0.125 inches wide.

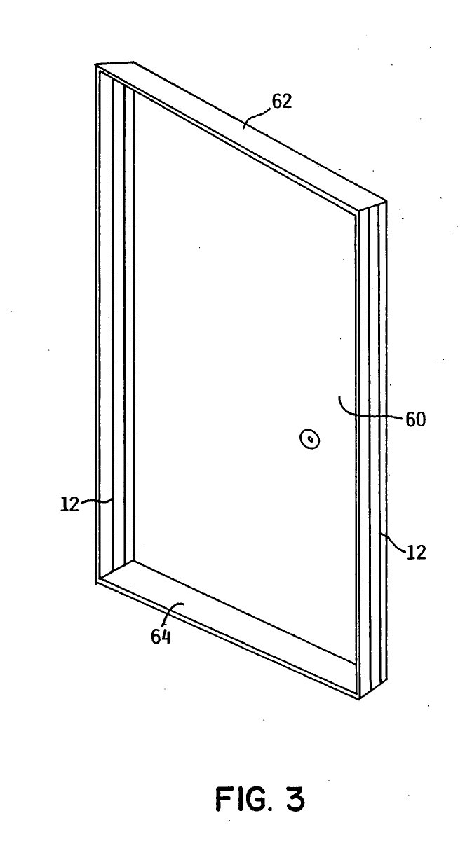

FIG. 3 shows a perspective view of a door frame incorporating the present invention. Frame members 12 are located on opposite sides of door 60. Head jamb 62 is located above door 60 and spans the distance between frame members 12. Door sill 64 is located below door 60 and also spans the distance between frame members 12. Frame members 12 may be any length suitable to span the distance between head jamb 62 and door sill 64. For example, frame members may be between 5 and 15 feet long, more preferably between 7 and 12 feet long.

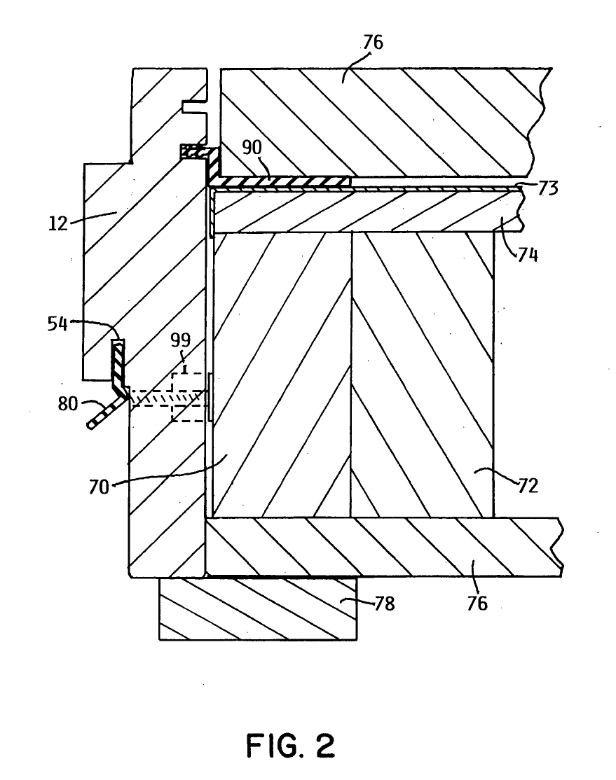

With reference to FIG. 2, the installation of the door frame apparatus 10 will now be discussed. In many structures, the door opening is defined by studs comprising, for example 2×4's or 2×6's. For purposes of this disclosure, it should be noted that 2×4's are approximately 3.5 inches long and 2×6's are approximately 5.5 inches long. In FIG. 2, 2×6's 70 and 72 are shown. The 2×6's 70 and 72 are surrounded by an exterior sheathing 74 on the exterior of the structure and an interior drywall 76 on the interior of the structure. Interior casing 78 is attached to interior drywall 76 and second end 44 of frame member 12 to hide the seam between frame member 12 and interior drywall 76 and provide for a more finished appearance. Weather strip 80 is shown in backcut 54 to create a tight seal when door 60 (not shown) is closed.

Interior drywall 76 can comprise a variety of thicknesses. For example, drywall 76 can measure about 0.5 inches thick. Alternatively, drywall 76 can measure about 0.625 inches thick if fire retardant properties are desired. This causes the distance between exterior sheathing 74 and interior casing 78 to vary, depending on the thickness of the interior drywall 76. For example, if 0.5 inch drywall is used, the distance between exterior sheathing 74 and interior casing 78 is 6.5625 inches. Alternatively, if 0.625 inch interior drywall is used, the distance between exterior sheathing 74 and interior casing 78 is 6.8125 inches.

Exterior sheath 74 can also have variable thickness causing similar wall surface variation. For example, if a 0.5 inch exterior sheath 74 is used, the distance between exterior sheathing 74 and interior casing 78 is 6.5625 inches. Alternatively, if a 0.625 inch exterior sheath is used, the distance between exterior sheathing 74 and interior casing 78 is 6.8125 inches. To accommodate this 0.25 inch variation caused by the differences in building materials and techniques, nail fin 90 can be used. House wrap 73 can cover exterior sheathing 74. House wrap 73 can be a moisture barrier, and have other beneficial properties, but is not necessary to the invention. Siding 76 covers exterior sheathing 74 to give it a more finished appearance. Jamb jack 99 is also shown in FIG. 2. Jamb jack 99 contains threads which can allow the jamb jack 99 to move with respect to frame member 12, and apply pressure against stud 70. Frame member 12 can include a plurality of jamb jacks 99 to assist in aligning the door frame in the door frame opening without the use of shims.

The details of nail fin 90 will be discussed with reference to FIG. 11. Nail fin 90 includes a flat portion 92, a lateral portion 94, a securing portion 96. A plurality of fins 98 are disposed on the securing portion 96. Flat portion 92 includes a front surface 102 and a back surface 104. The distance between front surface 102 and back surface 104 defines an area that is less than 0.2 inches thick, preferably less than 0.125 inches thick, more preferably, less than 0.0625 inches thick. Flat portion 92 is between 0.5 inches wide and 3 inches wide, preferably between 1 inch wide and 2 inches wide.

A plurality of pre-fabricated nail holes may be disposed along flat portion 92 to facilitate the fastening of nail fin 90 to sheathing 74 in FIG. 2. Lateral portion 94 forms an angle with respect to flat portion 92. The angle can be between 60 and 120 degrees, preferably between 80 and 100 degrees, more preferably 90 degrees. Similarly, lateral portion 94 forms an angle with respect to securing portion 96. The angle can be between 60 and 120 degrees, preferably between 80 and 100 degrees, more preferably 90 degrees. This enables flat portion to be offset with respect to fin 98. In one embodiment, lateral portion is less than 0.25 inches long. In a preferred embodiment, lateral portion is about 0.125 inches long.

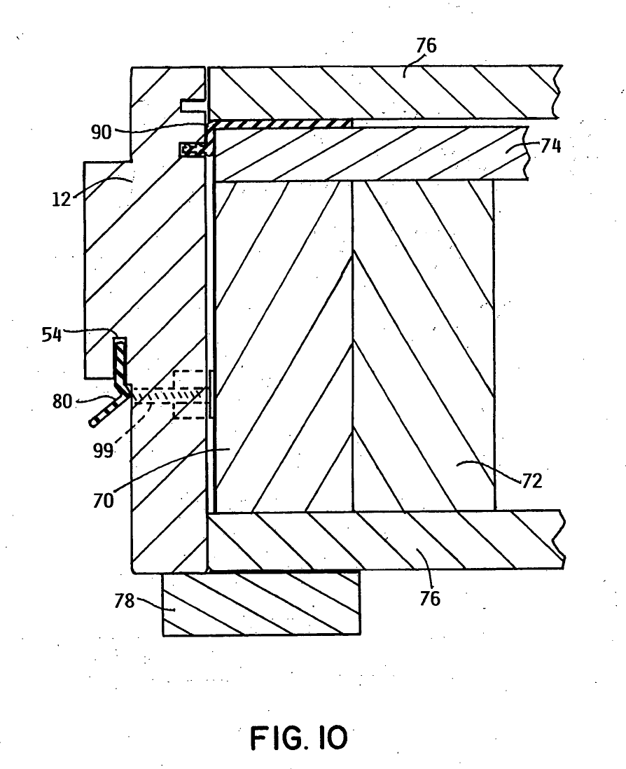

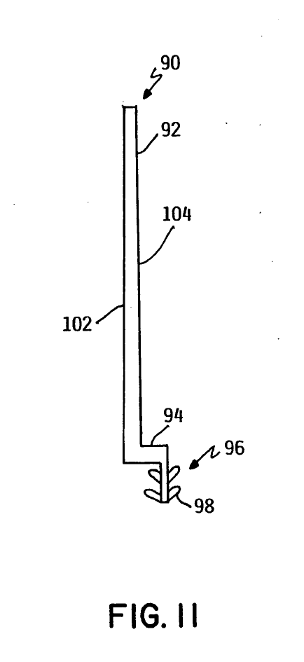

In a preferred embodiment, securing portion 96 is disposed in interior notch 50. The friction created by the plurality of fins 98 causes nail fin to remain secure in frame member 12. Nail fin 90 is entirely reversible. The reversible aspect of nail fin 90 allows frame member 12 to be used in a variety of settings, without the need for additional material as shown in FIGS. 9 and 10. For example, when nail fin 90 is positioned in interior notch 50 so that front surface 102 contacts sheathing 74, as shown in FIG. 9, the apparatus is able to accommodate door frames that use 0.5 inch drywall. Alternatively, when nail fin 90 is positioned in interior notch 50 so that the back surface 104 contacts sheathing 74, as shown in FIG. 10, the apparatus is able to accommodate door frames that use 0.625 inch thick drywall. Nail fin 90 can also be used when the structural frame is comprised of 2×4 material. In this instance, however, frame member 112 is used in conjunction with nail fin 90.

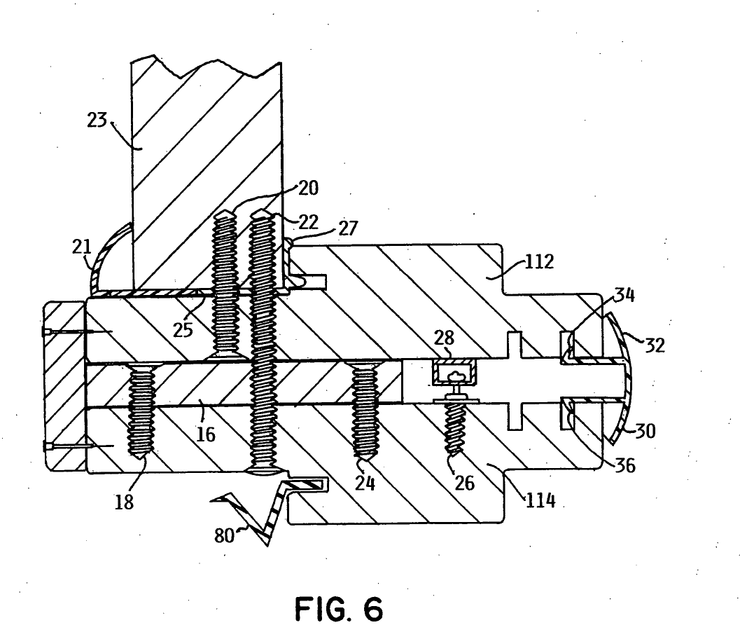

FIG. 6 shows the sidelight assembly of FIG. 1. However, FIG. 6 shows the apparatus 10 used with frame members 112 and 114 instead of frame members 12 and 14 that are shown in FIG. 1. Trim bead 21 is partially disposed between sidelite panel 23 and frame member 112 to provide for a finished outer appearance. A glazing shim 27 is positioned between frame member 112 and sidelite panel 23 to provide clearance for trim bead 21. Screws 20 and 22 are disposed through glazing shim 27. A bead of silicone is disposed between sidelite panel 23 and frame member 112 in and adjacent to backcut 154.

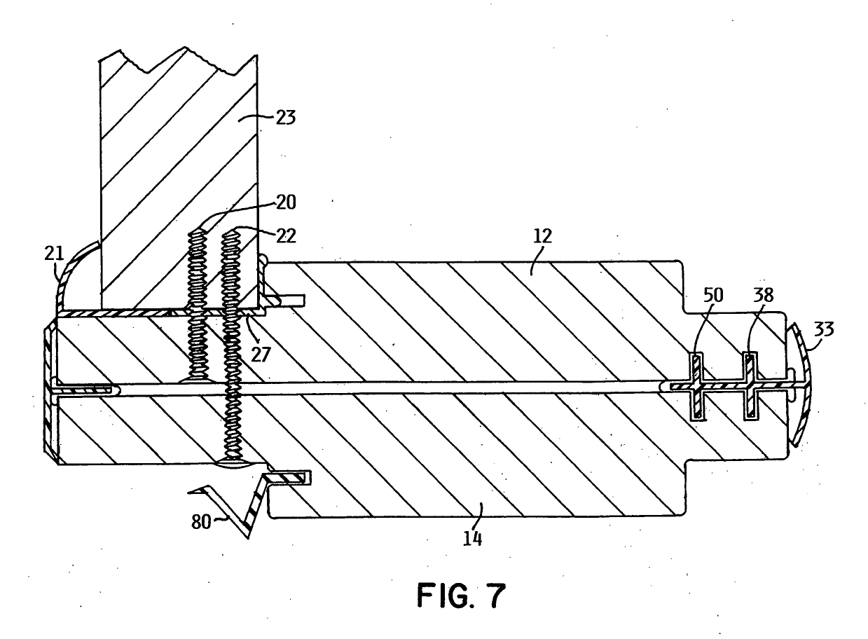

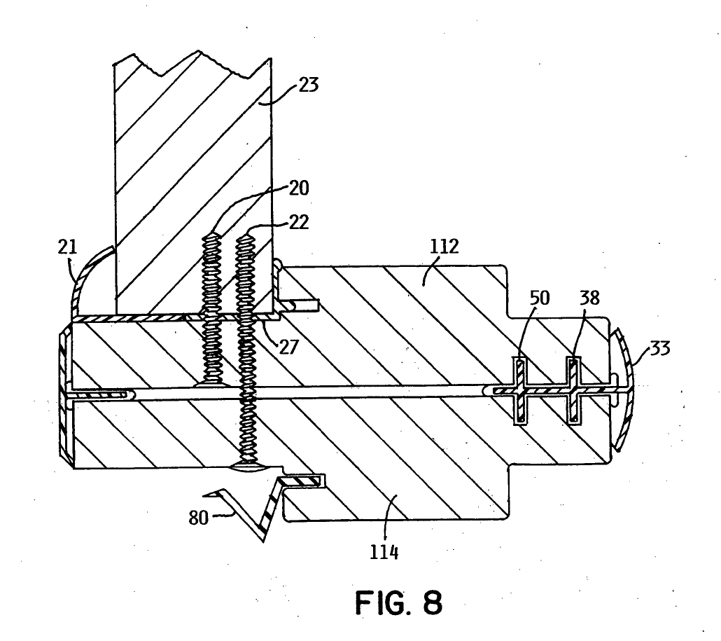

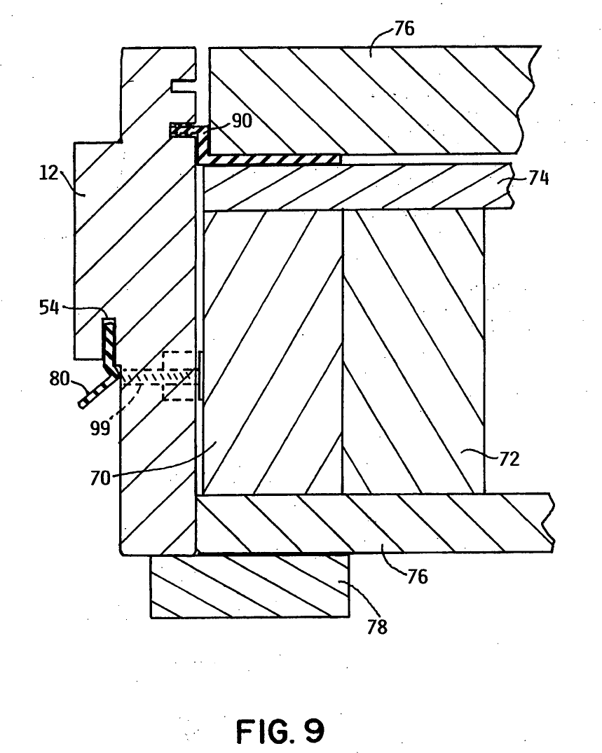

FIG. 7 shows a transom assembly configuration using frame members 12 and 14. Exterior mull 33 is partially disposed between frame members 12 and 14. To secure exterior mull 33 between frame members 12 and 13, exterior mull has fins extending between exterior notch 38 and interior notch 50. Similarly, FIG. 8 shows a transom assembly configuration using frame members 112 and 114. Exterior mull 33 is partially disposed between frame members 112 and 114. To secure exterior mull 33 between frame members 112 and 113, exterior mull 33 has fins extending between exterior notch 38 and interior notch 50.

What is claimed is:

1. A frame apparatus for a fenestration unit, the apparatus comprising:
at least one elongated frame member including a first side, a second side, a first end, and a second end, wherein the first side includes an exterior notch proximate the first end and the second side includes at least one backcut proximate the second end and ridge proximate the first end.

2. The apparatus of claim 1, further comprising an interior notch located on the first side adjacent to the exterior notch, wherein the interior notch has a centerline.

3. The apparatus of claim 2, wherein the second side of the elongated frame member includes a ridge proximate the first end.

4. The apparatus of claim 3, wherein the first side is less than 8 inches long.

5. The apparatus of claim 4, wherein the distance between the second end of the frame member and the centerline of the interior notch is between 4 inches and 7.5 inches.

6. The apparatus of claim 5, wherein the exterior notch is about 0.25 inches deep.

7. The apparatus of claim 6, wherein the ridge measures about 1.0625 inches along the second side and 0.5 inches along the first end.

8. The apparatus of claim 7, wherein the exterior notch is located at least 0.25 inches away from the interior notch.

9. The apparatus of claim 8, wherein a weather strip is at least partially disposed in the backcut.

10. The apparatus of claim 9, wherein an exterior mull is at least partially disposed in the exterior notch.

11. The apparatus of claim 10, further comprising a nail fin including an elongated flat portion, a lateral portion, and a securing portion, wherein the elongated flat portion is generally parallel to the securing portion.

12. The apparatus of claim 11, wherein the lateral portion of the nail fin is generally perpendicular to the flat portion of the nail fin.

13. The apparatus of claim 12, wherein the securing portion includes a plurality of fins.

14. The apparatus of claim 13, wherein the securing portion of the nail fin is disposed in the interior notch of the elongated frame member.

15. A frame apparatus for a fenestration unit, the apparatus comprising:
an elongated frame member including a first side and a second side, wherein the largest distance between the first side and the second side defines a width of about 1.25 inches, the elongated frame member also including a first end and a second end, wherein the largest distance between the first end and the second end defines a length of about 5.625 inches, wherein the first side includes an exterior notch at least 0.25 inches from the first end, wherein the exterior notch is at least 0.1 inches wide and at least 0.2 inches deep and the second side includes a backcut located at least 2.0 inches from the second end, wherein the backcut measures at least 0.25 inches deep and at least 0.1 inches wide and wherein the elongated frame member includes a ridge extending at least 1 inch from the first end and at least 0.25 inches from the second side.

16. The apparatus of claim 15, further comprising an interior notch having a centerline at least 0.25 inches from the first end, wherein the interior notch is at least 0.1 inches wide and at least 0.2 inches deep, wherein the distance between the second end of the frame member and the centerline of the interior notch is about 4.7175 inches..

17. The apparatus of claim 16, further comprising a jamb jack disposed in the frame member.

18. A frame apparatus for a door frame, the apparatus comprising:
an elongated frame member including a first side and a second side, wherein the largest distance between the first side and the second side defines a width of at least 1 inch, the elongated frame member also including a first end and a second end, wherein the largest distance between the first end and the second end defines a length of about 7.625 inches, wherein the first side includes an exterior notch at least 0.25 inches from the first end, wherein the exterior notch is at least 0.1 inches wide and at least 0.2 inches deep, wherein the first side also includes an interior notch having a centerline, wherein the centerline of the interior notch is about 6.7175 inches from the second end, and the second side includes a backcut located at least 2.0 inches from the second end, wherein the backcut measures at least 0.25 inches deep and at least 0.1 inches wide and wherein the elongated frame member includes a ridge extending at least 1 inch from the first end and at least 0.25 inches from the second side.

19. The frame apparatus of claim 18, further comprising a weather strip at least partially disposed in the backcut.

20. The frame apparatus of claim 19, wherein the apparatus includes a jamb jack disposed in a frame member.
